(19) United States
(12) Patent Application Publication
(10) Pub. No.: US 2009/0198771 A1
(43) Pub. Date: Aug. 6, 2009

(54) Client device and server device

(75) Inventors: Holger Pfaff, Bad Muender (DE); Gerd Leseberg, Bad Pyrmont (DE)

Correspondence Address: DeMont & Breyer, LLC, 100 Commons Way, Ste. 250, Holmdel, NJ, 07733, US

(73) Assignee: PHOENIX CONTACT GMBH & CO. KG, Blomberg (DE)

(21) Appl. No.: 12/360,995

(22) Filed: Jan. 28, 2009

(30) Foreign Application Priority Data
Feb. 1, 2008 (DE) 10 2008 007 579.5

(51) Int. Cl. G06F 15/16

(52) U.S. Cl. 709/203

(57) ABSTRACT

The invention relates to a client device that is constructed for communicating via a communications network with a remote server device on which a computer program is running. The client device includes a receiver device (101) for receiving a copy of the computer program via the communications network, a processor device (103) for carrying out a change in the copy of the computer program, and a transmitter device (105) for transmitting the change via the communications network to the remote server device.

The present invention relates to the field of information technology.

The classic problem of visualizing, for example, internal states of an electronic device or of processes consists in displaying application-specific or process-specific data of an automation application and giving the user the ability to influence this data and in this way to intervene in the underlying automation application in a controlling and regulating manner. In this way, the user can monitor underlying automation processes through a graphical display within the visualization or can influence these processes through the input of values or the activation of control elements.

A visualization is typically composed of a combination of graphical elements, of defined connections to process-specific sensors and actuators, and also of a stored control and authorization system. In the control system, for example, it is defined at which time which information is changed. In contrast, in the authorization system, it is defined which user may execute which function in the visualization. Here, a visualization is usually composed of several visualization pages that can be displayed, for example, on a screen.

The individual visualization pages themselves are often made available by a special program, usually by a service. A service is a program that runs at the operating system level, has no user interface, and makes defined services available. Depending on the type and method of each system, this service can run either on a local PC (PC: Personal Computer) or on a remote PC or server. The individual visualization pages thus lie either directly on the local PC and are displayed there or they are loaded via a network connection from a server onto the local PC and then displayed.

The service described above that makes the visualization pages available to the user is also designated as a “Runtime” routine. In the use of a server, however, access is made, for example, on the side of a user, to a local PC that requires at least one proprietary client software program. For system access, the Runtime routine runs on a server that also applies to a client for the use of browser plug-ins. In contrast, for the use of an individual PC, the Runtime routine runs on a local PC, because this simultaneously represents a server and a client. The client software makes available either its own control interface for the visualization or it expands the possibly existing client software, such as, for example, an Internet browser with corresponding functions, in order to be able to display and control the contents of the visualization. For Web clients, such function extensions are designated as “Plug-ins.”

The creation of a visualization with its functionalities is performed today through a proprietary, operating system-independent development environment on a local PC or a server. This has the disadvantage that a change or an expansion of the visualization is possible only with the proprietary development environment with which it was created. From this, the specification to the operating system supported by the development environment is simultaneously automatically generated. If the visualization is used on a remote server, then this must be retransmitted after each modification from a development computer, for example, from a local PC, to the server. Furthermore, the changes and creations of the visualization are linked to the location of the local PC on which the development software runs.

The problems mentioned above apply not only to visualization software, but analogously also to any computer program in a decentralized system or information scenario in which, for example, a computer program is stored or executed on a client computer and whose action extends to or can be specified from a local computer.

The problem of the invention is to create an efficient concept for handling computer programs in a decentralized system or information scenario.

This problem is solved by the features of the independent claims.

The invention relates to the case in which a computer program, for example, a client, that is managed, maintained, or modified by means of a local computer, is executed on a central computer, for example, on a server. According to the invention, for example, a copy of the program is transmitted from the server to the client by means of, for example, a wireless or a wired communications network. The copy of the program is used as a basis for carrying out changes in the program, wherein, for example, any change is transmitted to the server preferably in real time, whereupon the program that can be executed on the server can be modified.

According to one aspect, the invention relates to a client device that is constructed to communicate via a communications network to a remote server device on which a computer program runs. The client device comprises a receiver device for receiving a copy of the computer program via the communications network, a processor device for carrying out a change in the copy of the computer program, and a transmitter device for transmitting the change via the communications network to the remote server device.

According to one embodiment, the processor device is constructed to carry out a contact-related change in the copy of the computer program.

According to one embodiment, the transmitter device is constructed to transmit information on a mouse movement or on a keyboard input as the change.

According to one embodiment, the receiver device is constructed to receive a change program in addition to the copy of the computer program. Here, the processor device is constructed to execute the change program for carrying out the change.

According to one embodiment, the transmitter device or the receiver device is constructed to execute an Internet protocol for communications via the communications network.

According to one embodiment, the transmitter device or the receiver device is constructed to build or maintain a real-time connection via the communications network.

According to one embodiment, the computer program is a visualization program.

According to one aspect, the invention relates to a server device that is designed specific to the program for executing a computer program. The server device comprises a transmitter device for transmitting a copy of the computer program via a communications network, a receiver device for receiving a change to the computer program via the communications network, a processor device for changing the computer program under consideration of the change received, in order to produce a changed computer program. Here, the processor device is constructed to execute the changed computer program.

According to one embodiment, the receiver device is constructed to receive information on a mouse movement or on a keyboard input as the change.

According to one embodiment, the transmitter device is further constructed to transmit a change program via the communications network for carrying out a change in the computer program.

According to one embodiment, the transmitter device or the receiver device is constructed to execute an Internet protocol for communications via the communications network.

According to one embodiment, the transmitter device or the receiver device is constructed to build or maintain a real-time connection via the communications network.

According to one embodiment, the computer program is a visualization program.

According to one aspect, the invention relates to a communications system with the client device and the server device.

According to one aspect, the invention relates to a method for changing a computer program running on a server device using a client device. The method consists of receiving a copy of the computer program via a communications network, carrying out a change in the copy of the computer program, and transmitting the change via the communications network to the server device.

According to one aspect, the invention relates to a method for carrying out a change to a computer program with the transmission of a copy of the computer program via a communications network, receiving a change to the computer program via the communications network, changing the computer program under consideration of the change received, in order to produce a changed computer program, and executing the changed computer program.

According to one aspect, the invention relates to a decentralized method for changing a computer program with the steps of the method for changing a computer program running on a server device and the steps of the method for carrying out a change to a computer program.

According to one aspect, the invention relates to a computer program for executing one of the methods according to the invention when the computer program is running on a computer.

Additional embodiment examples will be explained with reference to the accompanying drawings. Shown are:

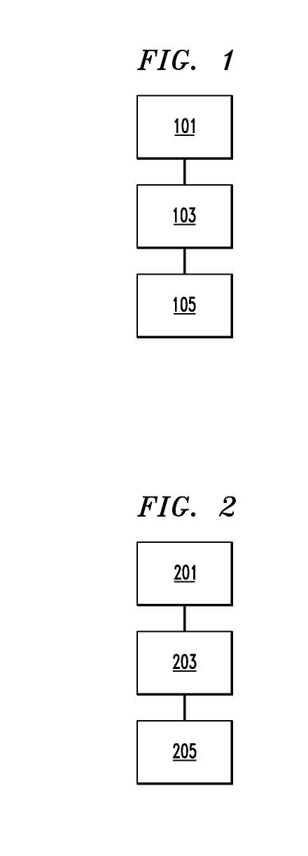

FIG. 1 is a client device,

FIG. 2 is a server device,

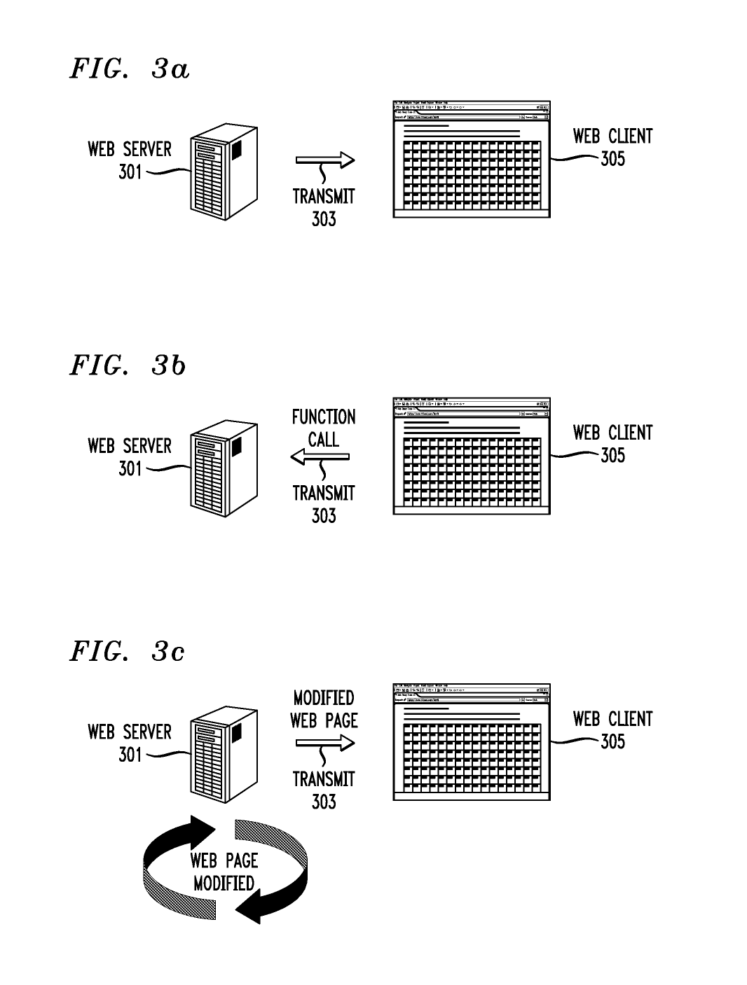

FIG. 3a-3c is a communications scenario, and

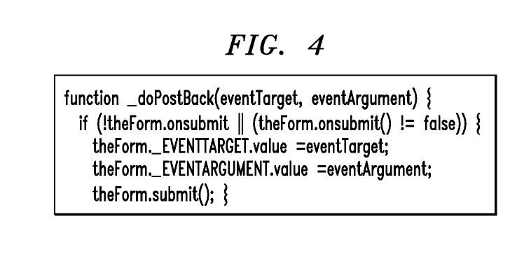

FIG. 4 is a program code.

FIG. 1 shows a client device with a receiver device 101, a processor device 103, and a transmitter device 105. The client device shown in FIG. 1 is provided to communicate with a remote server device via a communications network, for example, via an Internet communications network. The remote server device, for example, a central server, executes a program whose copy is transmitted via the communications network and is received by the client device. The processor device 103 carries out, for example, a change in the copy of the computer program, wherein the transmitter device 105 reports this change, for example, a change to a character or a mouse movement, to the server device preferably in real time.

The server device shown in FIG. 2 consists of a receiver device 201 for receiving the change to the computer program via the communications network, a processor device 203 connected after the receiver device 201 for changing the computer program based on the change received, and also a transmitter device 205 that is provided to transmit a copy of the computer program via the communications network, for example, to the remote client device.

The computer program can involve, for example, a visualization within a Web instance that could be composed of several Web pages. For example, a Web service with a (Web) server that is in the position to make Web pages available can be arranged around this visualization. Furthermore, a Web client is used, such as, for example, an Internet browser, that is in the position to display the Web pages. The Web client includes, for example, an integrated interpreter for a script language, in order to be able to execute a code within a displayed Web page. The Web service, e.g., a server, is here preferably provided to execute the program code at the operating-system level. On the server side, C++ or Java or J++ or VB (VB: Visual Basic), for example, can be used as the programming languages.

According to the invention, a technology is provided with which a visualization can be created without a proprietary development environment within a Web client with a connected Web server. In this way, it is possible to be able to create visualization pages on a suitable, remote Web server as the server device from any location by means of a PC. Here, it is assumed that the PC includes executable Web client software, such as, for example, a Web browser, as the client device and that a physical connection between the PC and the Web server exists, for example, via the Internet.

Consequently, the system according to the invention can include, for example, a local PC as a client device on which a Web service and Web client software can run. Alternatively, the system can be composed of a remote PC that is used, for example, as a Web server on which a service is running and at least one local PC that is used as the Web client on which Web client software, such as, for example, a Web browser is running. In this case, the Web browser and Web server are connected via a network. In this case, the client device can thus include the remote PC and/or the local PC. The Web server and the Web client can here support standard protocols, such as, for example, HTTP, in order to enable communications. The Web service running on the Web server makes available Web pages for retrieval that enable the client device, for example, the Web client, to modify visualization pages stored on the server within a Web instance, for example, with a Web browser, or to create and store new visualization pages.

The Web client connects, for example, to the Web browser and loads a Web page of a Web instance. The contents of the page represent the graphical user interface for creating visualization pages on the Web server and are designated below as the edit page. By means of this edit page, the Web server makes available to the Web client all of the functions for creating, editing, and managing visualization pages.

When the edit page is loaded, the client loads script elements that are embedded in the edit page and that make available to the user all of the necessary control functions. These script elements accept, for example, context-related mouse movements and keyboard inputs and forward these to the server. The server itself executes the associated stored functions, modifies the relevant contents of the visualization page, and transmits the modified page, parts of this page, or also a new page back to the client for further processing. Thus, the creation and storage of the visualization are realized directly on the Web server. Because the visualization pages involve Web pages, these can each be displayed and controlled with a typical Web client.

In FIGS. 3a to 3c, the sequence of the method according to the invention is displayed. Here, a Web server 301 is provided as a server device for communicating via a communications network 303 with a client device on which a Web client 305 is executed as a program. The Web client 305 requests, for example, a Web page from the Web server 301. Then the Web server 301 transmits the page to the Web client 305. The transmitted Web page contains, for example, a script code that can interact with editing functions stored on the server. The user activates, for example, a button, whereupon the Web client 305 transmits, for example, arguments (values) that are dependent on a position and an interaction back to the server. The server executes the associated function for modifying the displayed visualization page.

The function called on the server modifies the actual Web page on the server, stores the modification or the change, and transmits a new, modified page or parts of this page back to the client. The user can perform other modifications on the newly transmitted page until he is satisfied with the result, whereupon the editing process is ended.

FIG. 4 shows an embodiment example of a Java script that is executed when the elements on the page are activated, for example, when a button is pressed.

1. Client device that is constructed for communications via a communications network with a remote server device on which a computer program is running, the client device comprising:
a receiver device (101) for receiving a copy of the computer program via the communications network;
a processor device (103) for carrying out a change in the copy of the computer program; and
a transmitter device (105) for transmitting the change via the communications network to the remote server device.

2. Client device according to claim 1, wherein the processor device (103) is constructed to carry out a context-related change in the copy of the computer program.

3. Client device according to claim 1, wherein the transmitter device (105) is constructed to transmit information on a mouse movement or on a keyboard input as the change.

4. Client device according to claim 1, wherein the receiver device (101) is constructed to receive, in addition to the copy of the computer program, a change program and wherein the processor device (103) is constructed to execute the change program for carrying out the change.

5. Client device according to claim 1, wherein the transmitter device (105) or the receiver device (101) is constructed for executing an Internet protocol for communicating via the communications network.

6. Client device according to claim 1, wherein the transmitter device (105) or the receiver device (101) is constructed to build or to maintain a real-time connection via the communications network.

7. Client device according to claim 1, wherein the computer program is a visualization program.

8. Server device that is designed specific to the program for executing a computer program, the server device comprising:
a transmitter device (201) for transmitting a copy of the computer program via a communications network;
a receiver device (203) for receiving a change to the computer program via the communications network; and
a processor device (205) for changing the computer program under consideration of the change received, in order to produce a changed computer program,
wherein the processor device (205) is further constructed to execute the changed computer program.

9. Server device according to claim 8, wherein the receiver device (203) is constructed to receive information on a mouse movement or on a keyboard input as the change.

10. Server device according to claim 8, wherein the transmitter device (201) is further constructed to transmit via the communications network a change program for carrying out a change in the computer program.

11. Server device according to claim 8, wherein the transmitter device (201) or the receiver device (203) is constructed to execute an Internet protocol for communicating via the communications network.

12. Server device according to claim 8, wherein the transmitter device (201) or the receiver device (203) is constructed to build or to maintain a real-time connection via the communications network.

13. Server device according to claim 8, wherein the computer program is a visualization program.

14. Communications system comprising:
the client device according to claim 1 and
the server device according to claim 8.

15. Method for changing a computer program running on a server device using a client device, the method comprising:
receiving a copy of the computer program via a communications network,
carrying out a change in the copy of the computer program, and
transmitting the change via the communications network to the server device.

16. Method for carrying out a change in the computer program, the method comprising:
transmitting a copy of the computer program via a communications network,
receiving a change in the computer program via the communications network,
changing the computer program under consideration of the change received, in order to produce a changed computer program, and
executing the changed computer program.

17. Decentralized method for changing a computer program, the method comprising:
the steps of the method according to claim 15 and
the steps of the method according to claim 16.

18. Computer-readable storage medium for storing a computer program for executing the method of claim 15 when the computer program is running on a computer.
